(19) United States
(12) Patent Application Publication
(10) Pub. No.: US 2012/0041910 A1
(43) Pub. Date: Feb. 16, 2012

(54) METHOD OF ESTABLISHING A PROCESS DECISION SUPPORT SYSTEM

(76) Inventors: Jacques Ludik, Stellenbosch (ZA); Derick Wessels Moolman, Stellenbosch (ZA)

(21) Appl. No.: 13/265,406

(22) PCT Filed: Apr. 30, 2010
(86) PCT No.: PCT/IB10/51903

§ 371 Date: Oct. 20, 2011

(30) Foreign Application Priority Data
Apr. 30, 2009 (ZA) 2009/02987

(51) Int. Cl. G06F 15/18

(52) U.S. Cl. 706/12

(57) ABSTRACT

A method of establishing a process decision support system. Decision support systems of the kind are used in manufacturing processes, particularly industrial manufacturing processes, to monitor the performance of the processes in view of controlling the processes in order to optimise process production and quality. The method includes collecting process data of a process, collecting operational data of a process, and fusing the process data and operational data to create a fused data set (such as a consolidated rule set) of the process upon which process decisions (such as control decisions) may be taken. The process data and operational data may be fused according to methods of rules-based knowledge fusion, mathematical knowledge fusion, or case-based reasoning knowledge fusion.

### BACKGROUND OF THE INVENTION

1. Field of the Invention

The field of invention relates to a method of establishing a process decision support system. Decision support systems of the kind are used in manufacturing processes, particularly industrial manufacturing processes, to monitor the performance of the processes in view of controlling the processes in order to optimise process production and quality. The method of establishing a process decision support system is particularly applicable to smart process or asset monitoring.

2. Description of Related Art

Amongst others, the main sources of knowledge of a manufacturing process are: plant data (or process data) and operational data (the operational data including operating theory, operational rules and expert user input).

Expert Systems employ operational data to reproduce and simulate the input of human experts to analyze performance of a plant in order to control a plant process and, as a result, optimize production and quality. To this end, expert systems typically include a knowledge base that provides a formalized representation of the operational data (such as expert user input) to a rule base and an inference engine. The rule base and inference engine cooperate to simulate the reasoning that an expert user would have pursued in analyzing an outcome of a manufacturing process in order to make decisions regarding the eventual control of the process, either by manually controlling the process or by means of a control system.

Although Expert Systems are able to provide consistent solutions to repetitive decisions and processes upon which control decisions may be made, Expert Systems do not consider trends and patterns in plant or process data, nor any rules that may be derived, from the patterns in the plant or process data.

Data Mining searches and observes plant (or process) data for patterns that can be considered knowledge about the plant data. Data mining may implement processes of knowledge discovery, or prediction, or both. Knowledge discovery refers to the extraction of plant (or process) data rules that model the plant data and represent the knowledge about the plant data, for example through rule induction using association rule mining. Prediction refers to predictive modelling of future plant or process events, and may be implemented through rule-based techniques or neural networks that may have learning capabilities.

The knowledge discovered through data mining does not consider nor include operational data such as heuristics obtained, via expert user input.

Operational data provides an abstraction of how high-level actions of a process relate to low-level causes of the process. Such a level of abstraction is not easily obtained by data mining of plant data. Conversely, data mining of plant data uncovers explicit rules inherent in the plant process which are not easily identifiable by expert users.

The current invention aims to provide a method of establishing process decision support whereby process knowledge and plant knowledge are analyzed and combined to produce a consolidated knowledge set upon which actions can be taken to improve control of the process.

### BRIEF SUMMARY OF THE INVENTION

According to a broad aspect of the invention there is provided a method of establishing a process decision support system, the method including collecting process data of a process, collecting operational data of a process, and fusing the process data and operational data to create a fused data set (such as a consolidated rule set) of the process upon which process decisions (such as control decisions) may be taken. The process data and operational data may be fused according to methods of rules-based knowledge fusion, mathematical knowledge fusion, or case-based reasoning knowledge fusion.

According to one aspect of the invention there is provided a method of establishing a process decision support system. The method comprises: collecting process data of a process; collecting operational data of the process; defining process conditions for specific process performance from the process data and operational data; generating at least one data-driven rule from the process data; capturing at least one operational rule from the operational data; and fusing the at least one data-driven rule with the at least one operational rule to create a consolidated rule set.

According to another aspect of the invention there is provided a process decision support system comprising a software implementation of a set of computer executable instructions operable to execute a method of establishing a process decision support system. The method comprises: collecting process data of a process; collecting operational data of the process; defining process conditions for specific process performance from the process data and operational data; generating at least one data-driven rule from the process data; capturing at least one operational rule from the operational data; and fusing the at least one data-driven rule with the at least one operational rule to create a consolidated rule set.

Advantageously, the consolidated, rules-based and actions-based knowledge set should be complete in the sense that each rule of the set should have a corresponding action. In the absence of an action, a default action may be substituted. For the purpose of reporting applications or real-time applications, each rule would advantageously have a name reflecting a cause which resulted in poor performance for the one or more outcome classes of the one or more KPI's of the process.

It should be appreciated that the methods as hereinbefore described apply analogously to the establishing of an asset monitoring decision support system. To this end, the process and process-related terms as hereinbefore referred to, for example process data, may read to apply equally well to assets and asset-related terms, for example asset data.

The invention will now be described by way of non-limiting example with reference to the following drawings.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows a schematic flow diagram of a method of establishing a process decision support system according to one aspect of the invention;

FIG. 2 shows a schematic flow diagram of the fusing of data-driven rules with operational rules to create a consolidated rule set according to one aspect of the invention of FIG. 1;

FIG. 3 shows a schematic flow diagram of one aspect of the method wherein the data-driven rules are fused with the operational rules to create the consolidated rule set of FIGS. 1 and 2;

FIG. 4 shows a schematic flow diagram of another aspect of the method whereby the data-driven rules are fused with the operational rules to create the consolidated rule set of FIGS. 1 and 2;

FIGS. 5, 6, 7, 8 and 9 show examples of how rules are handled according to one aspect of the method and in particular according to how the consolidated rule set is created.

Unless otherwise indicated, like reference numerals denote like parts of the invention.

### DETAILED DESCRIPTION OF THE INVENTION

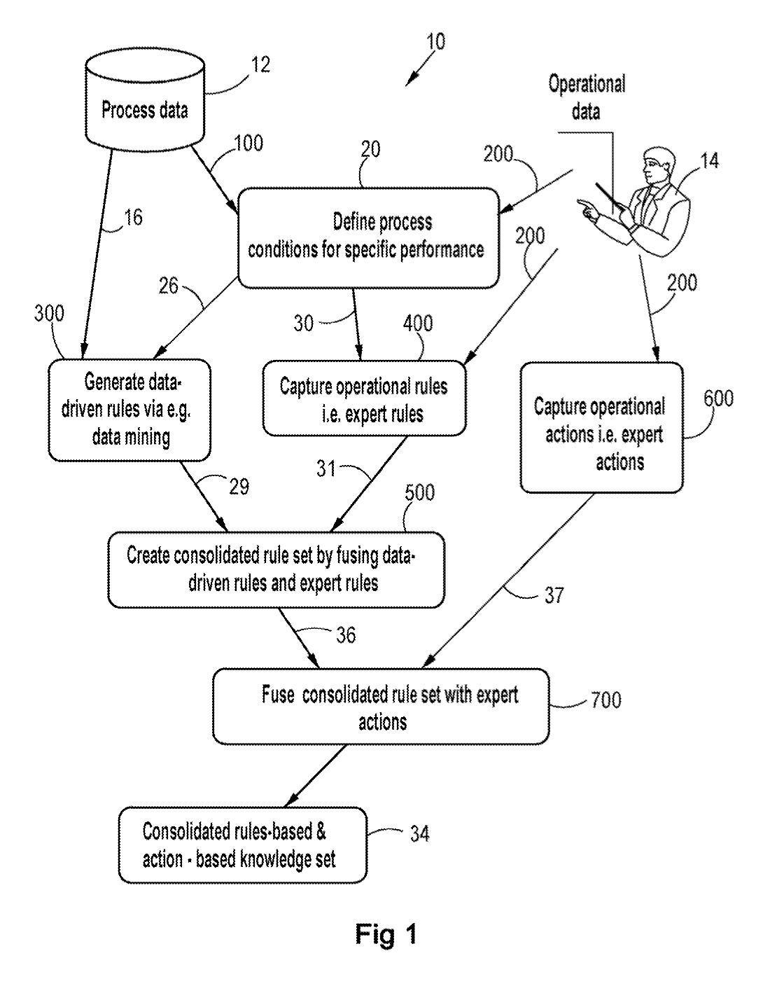

In FIG. 1, reference numeral 10 generally denotes a method of establishing a process decision support system in accordance with one aspect of the invention and applied to a manufacturing process according to one aspect of the invention.

The method 10 takes its inputs from two data sources namely process data 12 and operational data 14. The operational data 14 includes data that is typically used by Expert Systems to simulate the input of human experts in order to analyze performance of a plant or asset in order to control a plant process in view of optimizing process production and quality. The operational data includes expert plant operator input i.e. expert rules about the manufacturing process and associated expert actions that suggest actions to be taken to improve process performance related to the expert rules. The process data 12 represents data of the plant process itself, for example real-time process analysis data, through which explicit rules inherent in the plant process may be exploited.

The method 10 includes the following steps: At step 100, the process data 12 is collected and stored in a database. The process data will be used as a source for generating data-driven rules and for defining process conditions for specific performance of the process 20, as will become more apparent hereunder. At step 200, the operational data 14 is collected and stored in a database. The operational data, namely expert rules and expert actions, will be used as a source of expert rules of the process, a source of expert actions associated with the expert rules, and to define the process conditions for specific performance 20 of the process as will become more apparent in the steps that follow.

The process conditions for specific performance of the process are defined at 20 by selecting one or more key performance indicators (KPI's) of the process. Particular process data representative of the selected KPI's is collected from the process data 12, and expert rules representative of the selected KPI's are collected from the operational data 14. The collected expert rules are applied, to the process data representative of the selected KPI's, thereby defining outcome classes of the process by visually applying the collected expert rules to the process data to create rules-based definitions that specify the process conditions for specific performance 20, i.e. rules-based definitions of what constitutes good or poor process performance, and in particular what constitutes poor process performance. The outcome classes are ideally defined as ranges of process outcomes. The rules-based definitions that constitute poor process performance are used later in the method 10 to measure poor performance and acted upon to improve process performance.

Advantageously, the definition of the process conditions defines the scope of the fusing of data-driven rules with expert rules to create the consolidated rule set as will become more apparent at step 500. The definition serves as a clear specification for which outcome classes the method 10 must induce rules, and focuses the capturing of expert rules in step 400.

The data-driven rules are generated at step 300 and is done by data-mining of the process data 12 collected at step 100. The data-mining takes as input the outcome classes defined at 20 via 26, and includes the definition of discrete input classes corresponding to the outcome classes for the KPI's defined in the process conditions for specific performance at 20. In this embodiment of the method 10, the data-driven rules are established by inducing crisp rules for the discrete input classes, the rules operable to work with either continuous or discrete variables, or both. Although in this embodiment the data-driven rules are established via rule-indication, in other embodiments the rules may well be established by fuzzy rule induction.

The data-driven rules are generated by way of constructing decision trees, and the rules are customized based on an optimized version of the following algorithm for example:

For each Class C

Initialize to the set of all example E

While E contains examples in class C
Create a Rule R with an empty left-hand side that predicts class C
Until R is 100% accurate (or there are no more attributes to use) do:
   For each attribute A not in R, and each value v
      Consider adding the condition (attribute-value pair) A) v to the left hand side of R
      Select A and v to maximize the accuracy and covering of the attribute-value pair
   Add A) v to R
Remove the examples covered by R from E

As the data-driven rules are generated in step 300, the expert rules are captured at step 400. The capturing of the expert rules includes taking as sources, data from the definition of the conditions for process performance at 30, and expert rules 14 at step 200. The capturing of the expert rules is facilitated in software by using Decision Tables and by building one or more Decision Trees, and provision is made for the capturing of expert rules with multiple “AND” conditions in hierarchical format.

It should be noted that in another embodiment of the invention wherein the method 10 is applied to the establishing of an asset monitoring decision support system, provision is made for the capturing of multiple or even conditional actions associated with the expert rules.

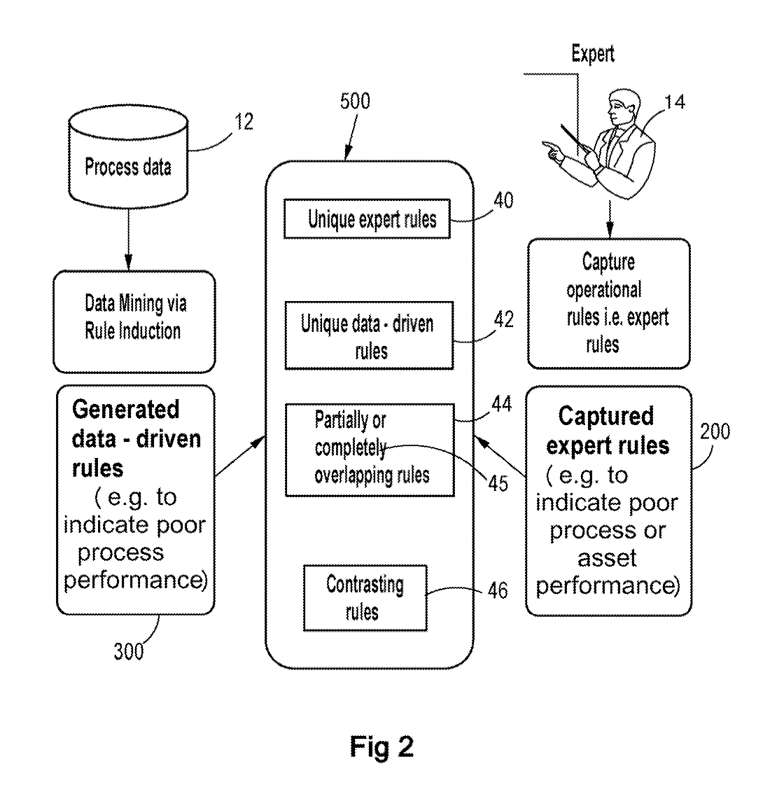

Step 500 denotes the fusing of the data-driven rules generated in step 300 and the expert rules captured at step 400 to create a consolidated rule set. This step may be viewed as a first fusion step of the method of establishing the process decision support system. The data-driven rules are taken at 29 and the expert rules taken at 31. The consolidated rule set is created as described in detail with reference to FIGS. 2, 3 and 4 hereunder, wherein the creation of subsets of rules is described. In addition, the consolidated rule set is optimized before passing it to step 600.

At step 600, the expert actions associated with the expert rules are captured from the operational data 14.

At step 700, a consolidated rules-based and actions-based knowledge set is created by fusing the consolidated rule set created in step 500 with the captured expert actions of step 600. This step may be viewed as a second fusion step of the method of establishing the process decision support system, the second fusion step taking its inputs from 36 and 37. The fusing is done by assigning to each of the rules of the consolidated rules set a corresponding expert action, and may include assigning expert actions to the subsets of rules of the consolidated rule set. The assigning may be automated through the use of software, or be done manually where the automated assigning is not workable. The resultant consolidated rules-based and actions-based knowledge set of 34 includes a collection of rules in which each rule of the subsets of rules created in step 500 has a corresponding expert action associated with it. Where no corresponding actions for a given rule are found (either automatically or manually), default actions are substituted.

With reference to steps 500 and 700, we notice that the method of establishing the process decision support system comprises two fusion steps, i.e. a first step of fusing the data-driven rules with the expert rules at step 500 to create the consolidated rule set, and a second step of fusing the consolidated rule set created at step 500 with the expert actions captured at step 600.

Referring now to FIG. 2, reference numeral 500 shows the step of fusing the data-driven rules of step 300 and the expert rules captured at step 400 to create the consolidated rule set in more detail. Continuing from FIG. 1, numeral 12 again shows the process data and numeral 14 the operational data, i.e. expert data that are used in the generation of the data-driven rules at step 300 and the capturing of the expert rules at step 200. The fusing of the data-driven rules and expert rules begin with the defining of the following categories of rules: unique expert rules 40, unique data-driven rules 42, partially overlapping rules, completely overlapping rules 45 and contrasting rules 46, and the fusion process is executed by a fusion engine, the engine referring to the computerized and programmed methodology used in fusing of the data-driven and expert rules.

In combining, or fusing, of the data-driven rules with the expert rules, the fusion engine must, amongst others, deal with a monotonicity constraint. A brief logic of the constraint is given here merely for the purpose of highlighting a challenge which the method as described aims to overcome. The monotonicity constraint demands that an increase in a certain input (in this case a rule) cannot lead to a decrease in an output that fuses the rule. For example, given a dataset:

D={xi,yi}ni=1,with xi=(xi1,xi2, . . . ,xim)εX=X1×X2× . . . Xm,and a partial ordering≦defined over this input space X.

Over the space Y of class values yi, a linear ordering≦is defined. Then the classifier f: xi→f(xi)εY is monotone if the following equation holds:

xi≦xj [symbol] f(xi)≦f(xj),∀i,j(or f(xi)≧f(xj),∀i,j)

In an unrelated example and merely for the purpose of explanation, for instance, increasing income whilst keeping other variables equal, should yield a decreasing probability of loan default. Therefore if a client A has the same characteristics as a client B, but a lower income, then it cannot be that client A is classified as a good customer and client B as a bad one. A similar reasoning applies to the outcome classes of the method as described.

The fusing of the data-driven rules with the expert rules include identifying of different subsets of rules to be fused by categorizing the subsets of rules according to the categories of rules. Heuristics are defined to distinguish between different types of data-driven and expert rules, and the rules are mapped and grouped into the categories.

The subsets of rules are fused by considering fusing of each category of rules:

For the subset of rules classified as unique data-driven rules, the rules are validated and criteria are defined for the inclusion of the rules in the consolidated rule set. By default, the unique data-driven rules are included in the consolidated rule set.

Likewise, for the subset of rules classified as unique expert rules, criteria are defined for the inclusion of the rules in the consolidated rule set. By default, the unique expert rules are included in the consolidated rule set.

For the subset of rules classified as completely overlapping data-driven and expert rules, the rules are by default included in the consolidated rule set.

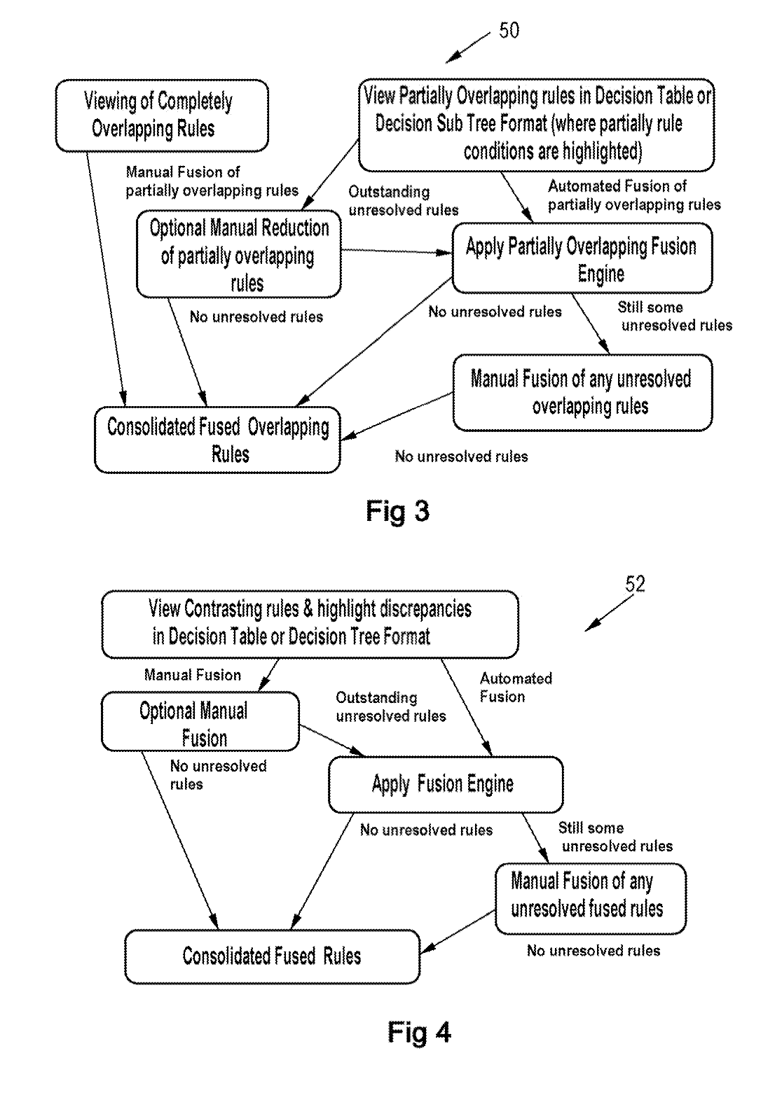

In FIG. 3, reference numeral 50 denotes a flow diagram of how the subset of rules classified as partially overlapping are dealt with. Decision tables and Decision sub-trees are generated to visualize and classify the rules as unique or to reduce the rules to completely overlapping rules. The fusion engine automatically reduces rules as shown in the figure, and manual reduction of the rules is used where the fusion engine is unable to resolve the rules.

In FIG. 4 reference numeral 52 denotes a flow diagram of how the subset of rules classified as contrasting rules are reduced for inclusion in the consolidated rule set. Similar to the case of partially overlapping rules, Decision Tables and Decision sub-trees are used to reduce the rules to the consolidated rule set, and hard and soft constraints are employed by the fusion engine to resolve the rules. To this end, rule conditions such as temperature, flow and power and rule outcome classes such good or bad are defined and considered. Different types of contrasting rules are evaluated by the fusion engine, by, for example, considering similar conditions and different rule outcomes, which results in the rules being dealt with as overriding expert rules or overriding data rules. Where contrasting conditions and similar rule outcomes exist, hard constraints are applied to reduce the rules to the consolidated rule set.

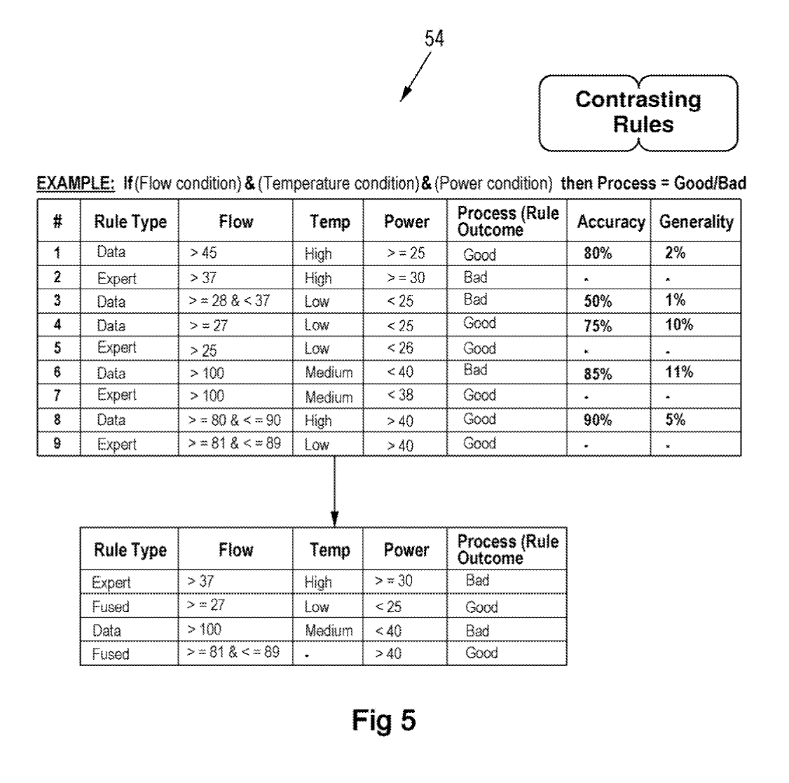

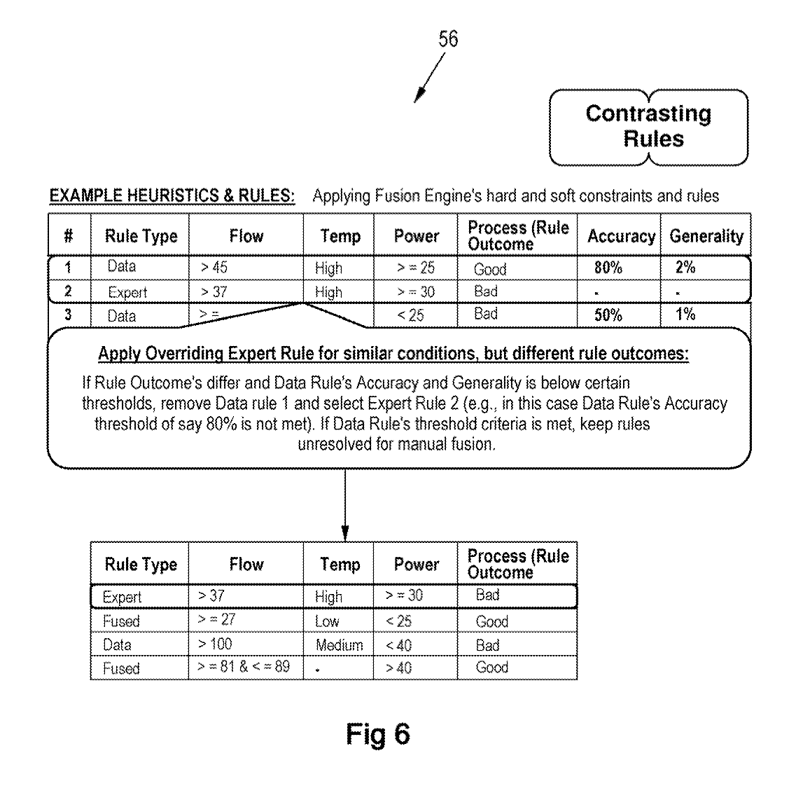

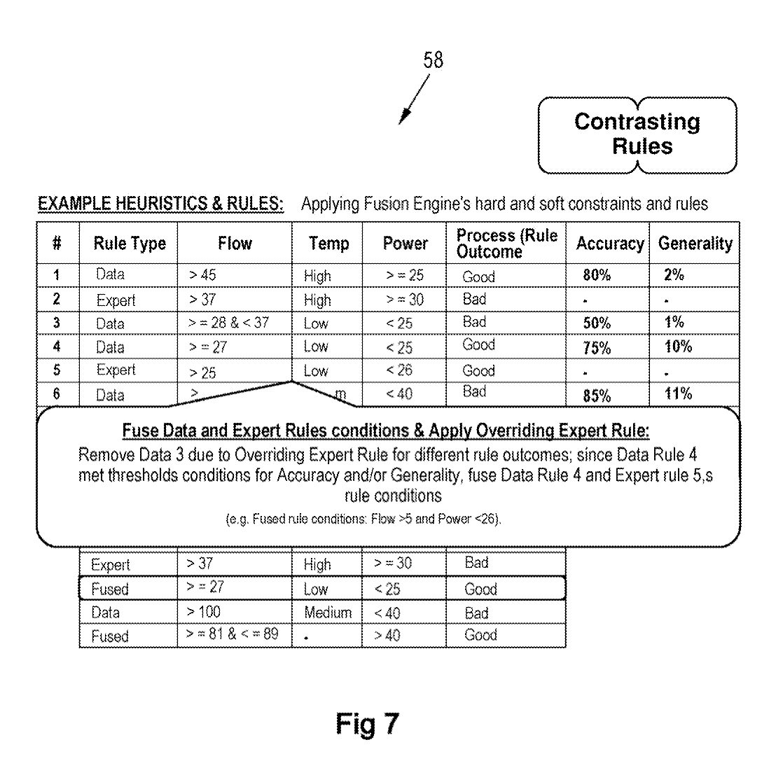

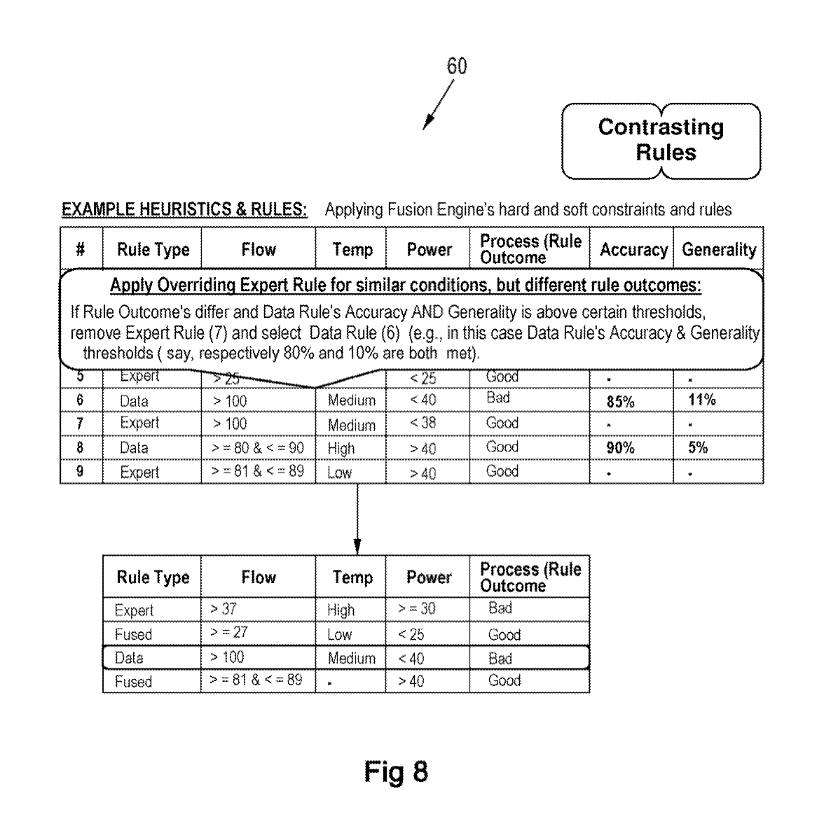

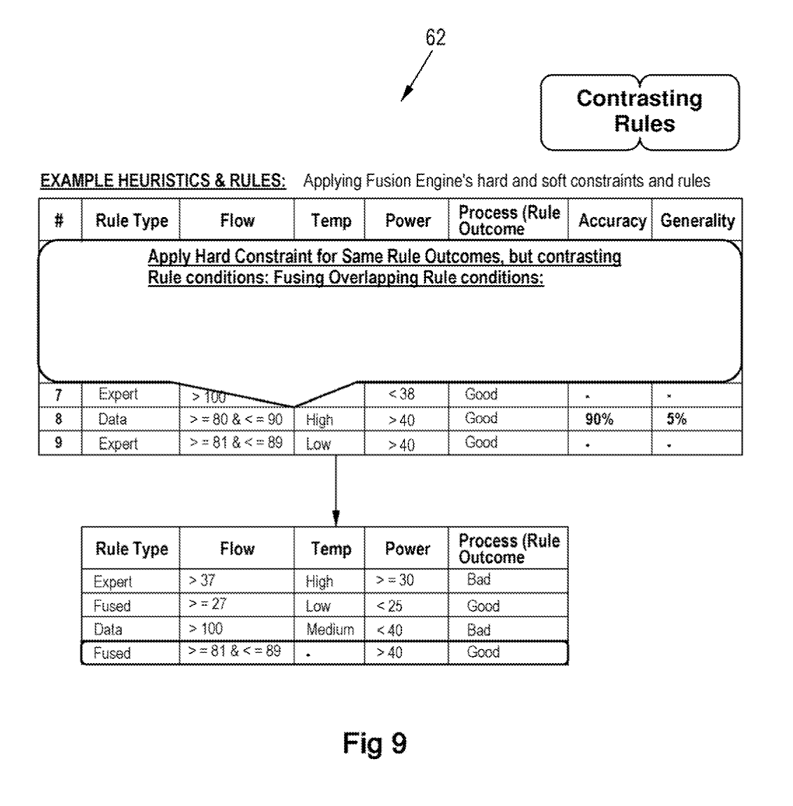

In FIGS. 5 through 9, numerals 54, 56, 58, 60 and 62 give examples of how the contrasting rules are dealt with for illustrative purposes.

What is claimed is:

1-33. (canceled)

34. A method of establishing a process decision support system, the method comprising:
collecting process data of a process;
collecting operational data of the process;
defining process conditions for specific process performance from the process data and the operational data;
generating at least one data-driven rule from the process data;
capturing at least one operational rule from the operational data; and
fusing the at least one data-driven rule with the at least one operational rule to create a consolidated rule set.

35. The method as claimed in claim 34 wherein the operational data comprises at least one of operational rules, expert data, expert rules, expert actions, and process operating theory.

36. The method as claimed in claim 35 further comprising capturing at least one expert action from the operational data.

37. The method as claimed in claim 36 further comprising fusing the consolidated rule set with the at least one captured expert action to create a consolidated rules and actions-based knowledge set.

38. The method as claimed in claim 35 wherein defining process conditions for specific process performance comprises defining at least one outcome class of at least one Key Performance Indicator (KPI) of the process.

39. The method as claimed in claim 38 wherein the at least one outcome class is defined for KPI's having a range of at least discrete values, or continuous values, or both.

40. The method as claimed in claim 39 wherein defining process conditions for specific process performance comprises collecting process data representative of the at least one KPI;
collecting expert rules from the operational data; and
applying the collected expert rules to the process data representative of the at least one KPI to define the at least one outcome class.

41. The method as claimed in claim 40 wherein applying the collected expert rules to the process data comprises visually applying the rules to the process data to define the at least one outcome class.

42. The method as claimed in claim 40 wherein applying the collected expert rules to the process data comprises rules-based defining of the at least one outcome class to specify the process conditions for specific performance.

43. The method as claimed in claim 40 wherein generating at least one data driven rule comprises data mining of the process data.

44. The method as claimed in claim 43 wherein data mining of the process data comprises defining at least one outcome class corresponding to the at least one outcome class of the at least one KPI.

45. The method as claimed in claim 44 wherein generating at least one data-driven rule comprises inducing at least one crisp rule.

46. The method as claimed in claim 44 wherein generating at least one data-driven rule comprises inducing at least one fuzzy rule.

47. The method as claimed in claim 43 further comprising constructing a decision tree to enable generating the at least one data-driven rule.

48. The method as claimed in claim 34 wherein capturing the at least one operational rule from the operational data comprises using at least one of a decision table, a decision tree, and capturing rules with multiple “and” conditions in hierarchical format.

49. The method as claimed in claim 34 wherein fusing the at least one data-driven rule with the at least one operational rule to create the consolidated rule set comprises:
defining at least one category of rules;
grouping the at least one operational rule and the at least one data-driven rule into a subset of rules according to the at least one category; and
fusing the at least one subset of rules to create the consolidated rule set.

50. The method as claimed in claim 49 wherein the at least one category comprises at least one of unique expert rules, unique data-driven rules, completely overlapping rules, partially overlapping rules and contrasting rules.

51. The method as claimed in claim 50 wherein fusing is effected by a software implemented fusion engine.

52. The method as claimed in claim 51 wherein fusing the at least one subset of rules comprises, by default, including in the consolidated rule set at least one rule categorized as a unique expert rule.

53. A method as claimed in claim 51 wherein fusing the at least one subset of rules comprises, by default, including in the consolidated rule set at least one rule categorized as a unique data-driven rule.

54. The method as claimed in claim 51 wherein fusing the at least one subset of rules comprises, by default, including in the consolidated rule set at least one rule categorized as a completely overlapping rule.

55. The method as claimed in claim 51 wherein fusing the at least one subset of rules comprises reducing at least one rule categorized as a partially overlapping rule to a unique rule or to a completely overlapping rule.

56. The method as claimed in claim 55 wherein reducing the at least one partially overlapping rule comprises generating Decision Tables, or a Decision Sub-tree, or both, for classifying the at least one partially overlapping rule.

57. The method as claimed in claim 55 wherein reducing the at least one partially overlapping rule is automated and effected by the fusion engine.

58. The method as claimed in claim 57 wherein reducing the at least one partially overlapping rule provides for manual intervention by a user in order to reduce unresolved rules to the at least one subset of rules.

59. The method as claimed in claim 51 wherein fusing the at least one subset of rules comprises fusing at least two rules categorized as contrasting rules.

60. The method as claimed in claim 59 wherein fusing at least two contrasting rules is effected by applying at least one of hard constraints, soft constraints and thresholds to fuse the at least two contrasting rules into the consolidated rule set to ensure that the rules meet a monotonic constraint.

61. The method as claimed in claim 49 wherein, prior to grouping the at least one operational rule and the at least one data-driven rule into a subset of rules, defining at least one heuristic for categorizing the at least one data-driven rule and at least one operational rule into the at least one category of rules.

62. The method as claimed in claim 37 wherein creating the consolidated rules and actions-based knowledge set comprises assigning at least one of the at least one expert action to at least one rule of the consolidated rule set.

63. The method as claimed in claim 62 wherein assigning the at least one of the at least one expert action comprises manually assigning at least one action to the at least one rule of the consolidated rule set.

64. A process decision support system comprising a software implementation of a set of computer executable instructions operable to execute a method of establishing a process decision support system, the method comprising:
collecting process data of a process;
collecting operational data of the process;
defining process conditions for specific process performance from the process data and the operational data;
generating at least one data-driven rule from the process data;
capturing at least one operational rule from the operational data; and
fusing the at least one data-driven rule with the at least one operational rule to create a consolidated rule set.
